(19) United States
(12) Patent Application Publication
(10) Pub. No.: US 2026/0087969 A1
(43) Pub. Date: Mar. 26, 2026

(54) BRIGHTNESS COMPENSATION METHOD FOR DISPLAY PANEL AND ELECTRONIC DEVICE

(71) Applicant: Honor Device Co., Ltd., Shenzhen (CN)

(72) Inventors: Peilin WU, Shenzhen (CN); Jian BAI, Shenzhen (CN); Dashuai HU, Shenzhen (CN)

(21) Appl. No.: 19/398,212

(22) Filed: Nov. 24, 2025

Related U.S. Application Data
(63) Continuation of application No. PCT/CN2024/079466, filed on Feb. 29, 2024.

(30) Foreign Application Priority Data
Jul. 31, 2023 (CN) 202310956022.4

(51) Int. Cl. G09G 3/20

(52) U.S. Cl. CPC G09G 3/2092; G09G 2320/0233; G09G 2320/0271; G09G 2360/144

(57) ABSTRACT

This application provides a brightness compensation method for a display panel. The method includes: when detecting that the display panel displays a to-be-displayed image at a current display brightness value, determining a brightness interval in which the current display brightness value is located; determining gray level intervals corresponding to the brightness interval; and obtaining a gray level of the to-be-displayed image, and compensating each pixel unit in the display panel based on a brightness compensation value corresponding to a gray level interval in which the gray level is located.

### CROSS-REFERENCE TO RELATED APPLICATIONS

This application is a continuation of International Application No. PCT/CN2024/079466, filed on Feb. 29, 2024, which claims priority to Chinese Patent Application No. 202310956022.4, filed on Jul. 31, 2023, both of which are incorporated herein by reference in their entireties.

### TECHNICAL FIELD

This application relates to the field of display technologies, and in particular, to a brightness compensation method for a display panel and an electronic device.

### BACKGROUND

Currently, a brightness display unevenness (mura) phenomenon may occur in a display process of a display panel, affecting a display effect of the display panel. In the conventional technology, brightness compensation may be performed on the display panel to eliminate the mura phenomenon. However, the conventional technology is not effective enough in eliminating the mura phenomenon.

### SUMMARY

Embodiments of this application provide a brightness compensation method for a display panel and an electronic device, to dynamically adjust a brightness compensation value of the display panel based on display brightness value, thereby improving a display effect.

To achieve the foregoing objective, the following technical solutions are used in embodiments of this application:

According to a first aspect, a brightness compensation method for a display panel is provided. The method includes: when detecting that the display panel displays a to-be-displayed image at a current display brightness value, determining a brightness interval in which the current display brightness value is located, where difference information between mura images presented on the display panel at display brightness values in a same brightness interval is within a first preset difference range; determining gray level intervals corresponding to the brightness interval, where the gray level intervals corresponding to the brightness interval are determined based on gray level node values corresponding to the brightness interval, different brightness intervals correspond to different gray level node values, different gray level intervals correspond to different brightness compensation values, and the brightness compensation value is a difference between an actual brightness value of each pixel unit in the display panel in a corresponding gray level interval and a target brightness value; and obtaining a gray level of the to-be-displayed image, and compensating each pixel unit in the display panel based on a brightness compensation value corresponding to a gray level interval in which the gray level is located.

By using this technical solution, an electronic device may perform brightness interval division in advance, set different gray level node values for different brightness intervals, and set different corresponding brightness compensation values for gray level intervals including gray level node values in a same brightness interval. Respectively corresponding brightness compensation values may be calculated for the display panel at a preset gray level based on two different pre-selected display brightness values by using a demura algorithm. Then, when the current display brightness value changes across intervals, the corresponding gray level node values may be determined based on the brightness interval in which the current display brightness value is located. In other words, brightness compensation values respectively corresponding to different gray level intervals including the corresponding gray level node values in the brightness interval are determined. Therefore, after the gray level of the to-be-displayed image of the display panel is obtained, the corresponding brightness compensation value is selected based on the gray level interval in which the gray level is located, to compensate each pixel unit in the display panel. Finally, the display panel displays a displayed image obtained after brightness compensation, so that brightness unevenness of the display panel can be eliminated.

The foregoing current display brightness value may be an initialized display brightness value, or may be an adjusted display brightness value, for example, may be a display brightness value obtained by adjusting a previous display brightness value.

After the corresponding gray level node values are determined based on the brightness interval in which the current display brightness value is located, the gray level node values and the current display brightness value are packaged and delivered to a register, in other words, gray level node values stored in the register are modified. Then, a display driver selects the corresponding brightness compensation value based on the gray level interval in which the gray level of the to-be-displayed image is located, to perform brightness compensation. It may be understood that two pre-calculated brightness compensation values are stored in the register. After obtaining a brightness interval corresponding to an initial brightness value, the electronic device stores, in the register, gray level node values corresponding to the brightness interval, so that an IC chip selects the corresponding brightness compensation value based on the gray level interval in which the gray level of the to-be-displayed image is located. After it is detected that the display brightness value crosses brightness intervals, gray level node values corresponding to a new brightness interval are obtained and written into the register, so that the IC chip selects the corresponding brightness compensation value based on the gray level interval in which the gray level of the current to-be-displayed image is located. In other words, each time a display brightness value changes across brightness intervals, gray level node values stored in the register are updated. In addition, the current display brightness value and updated gray level node values corresponding to a brightness interval in which the current display brightness value is located are packaged and delivered in a same frame, so that when the display panel displays a next frame of to-be-displayed image, the display brightness value matches the gray level node values of the brightness interval in which the display brightness value is located.

In a possible implementation, the display panel corresponds to brightness compensation values corresponding to target gray level node values of a plurality of display brightness values in advance, and the brightness interval corresponds to a first gray level interval and a second gray level interval; a brightness compensation value corresponding to the first gray level interval is a brightness compensation value corresponding to a target gray level node value of a first display brightness value in the plurality of display brightness values, and a difference between image information of a mura image corresponding to the first gray level interval and image information of a mura image corresponding to the target gray level node value of the first display brightness value is the smallest; and a brightness compensation value corresponding to the second level interval is a brightness compensation value corresponding to a target gray level node value of a second display brightness value in the plurality of display brightness values, and a difference between image information of a mura image corresponding to the second gray level interval and image information of a mura image corresponding to the target gray level node value of the second display brightness value is the smallest.

It may be understood that, before delivery, the electronic device separately compares the image information of the mura image corresponding to the first gray level interval with the image information of the mura image corresponding to the target gray level node value of the first display brightness value and the image information of the mura image corresponding to the target gray level node value of the second display brightness value, to determine the brightness compensation value of the display panel in the first gray level interval; and separately compares the image information of the mura image corresponding to the second gray level interval with the image information of the mura image corresponding to the target gray level node value of the first display brightness value and the image information of the mura image corresponding to the target gray level node value of the second display brightness value, to determine the brightness compensation value of the display panel in the second gray level interval. In other words, the two brightness compensation values are burned into the register of the electronic device at delivery.

In a possible implementation, the brightness interval further includes a third gray level interval, a gray level in the third gray level interval is greater than a gray level in the first gray level interval, and the gray level in the third gray level interval is less than a gray level in the second gray level interval; and a brightness compensation solution corresponding to the third gray level interval is obtained through analysis by using a fitting curve of a brightness compensation value based on the brightness compensation value of the first gray level interval, gray levels of the first gray level interval, the brightness compensation value of the second gray level interval, and gray levels of the second gray level interval, where the fitting curve of the brightness compensation value is used to indicate a trend of a change of the brightness compensation value with the gray level interval. A method for determining the fitting curve is not limited in this application, and any one of existing methods for determining the fitting curve may be used.

In a possible implementation, the display panel corresponds to mura images presented at the plurality of display brightness values, and the plurality of display brightness values include the first display brightness value and the second display brightness value, where difference information between a mura image presented on the display panel at the first display brightness value and a mura image presented on the display panel at the second display brightness value is greater than a second preset difference range, and the second display brightness value is greater than the first display brightness value; the brightness compensation value corresponding to the target gray level node value of the first display brightness value is obtained by performing brightness compensation on the display panel in the target gray level node value of the first display brightness value; and the brightness compensation value corresponding to the target gray level node value of the second display brightness value is obtained by performing brightness compensation on the display panel in the target gray level node value of the second display brightness value.

In a possible implementation, the brightness interval corresponds to the first gray level interval and the second gray level interval; and a smaller display brightness value in the brightness interval indicates a larger proportion of the first gray level interval corresponding to the brightness interval in a total gray level range, and a smaller display brightness value in the brightness interval indicates a smaller proportion of the second gray level interval corresponding to the brightness interval in the total gray level range.

In a possible implementation, the compensating each pixel unit in the display panel based on a brightness compensation value corresponding to a gray level interval in which the gray level is located includes: if the gray level is located in the first gray level interval corresponding to the brightness interval, compensating each pixel unit in the display panel based on the first brightness compensation value corresponding to the first gray level interval; if the gray level is located in the second gray level interval corresponding to the brightness interval, compensating each pixel unit in the display panel based on the second brightness compensation value corresponding to the second gray level interval; or if the gray level is located in the third gray level interval corresponding to the brightness interval, compensating each pixel unit in the display panel based on the third brightness compensation value corresponding to the third gray level interval. In this solution, the corresponding brightness compensation value may be determined based on the gray level interval in which the gray level of the to-be-displayed image is located and the current display brightness value, to compensate the display panel.

In a possible implementation, the method further includes: in response to a scanning start signal of the to-be-displayed image, packaging and delivering, to the display driver of the electronic device, the current display brightness value and a gray level node value corresponding to the current display brightness value together. The current display brightness value and the gray level node value corresponding to the current display brightness value are delivered in a same frame, so that it can be ensured that the display brightness value and the gray level node values corresponding to the brightness interval in which the display brightness value is located take effect when a same frame of image is displayed. In addition, the current display brightness value and the gray level node value corresponding to the current display brightness value are delivered at a high level, instead of delivering, at a low level, the current display brightness value and the gray level node value corresponding to the current display brightness value, and are delivered in synchronization with a TE signal, so that it can be ensured that the current display brightness value matches the gray level node value.

In a possible implementation, the method further includes: in response to an adjustment instruction of a user for a display brightness value of the display panel, detecting the current display brightness value of the display panel, where the adjustment instruction is used to indicate that the current display brightness value of the display panel changes across intervals; or when detecting that ambient light brightness of the display panel changes, detecting the current display brightness value of the display panel.

In a possible implementation, after the obtaining a gray level of the to-be-displayed image of the display panel, and compensating each pixel unit in the display panel based on a brightness compensation value corresponding to a gray level interval in which the gray level is located, the method further includes: driving the display panel to display the to-be-displayed image. In this case, brightness compensation has been performed on the image displayed on the display panel, so that a brightness unevenness phenomenon can be eliminated.

According to a second aspect, this application provides an electronic device. The electronic device includes a display screen, a memory, and one or more processors; the display screen includes a display panel; the display screen, the memory, and the processors are coupled; and the memory is configured to store computer program code, the computer program code includes computer instructions, and when the computer instructions are executed by the electronic device, the electronic device is enabled to execute the method according to any implementation of the first aspect.

According to a third aspect, this application provides a computer-readable storage medium. The computer-readable storage medium stores instructions, and when the instructions are run on a computer, the computer is enabled to execute the charging method according to any implementation of the first aspect.

According to a fourth aspect, this application provides a computer program product including instructions. When the computer program product is run on a computer, the computer is enabled to execute the method according to any implementation of the first aspect.

It may be understood that the electronic device according to the second aspect, the computer-readable storage medium according to the third aspect, and the computer program product according to the fourth aspect that are provided above are all configured to execute the corresponding method provided above. Therefore, for beneficial effects that can be achieved by these devices, refer to the beneficial effects in the corresponding method provided above. Details are not described herein again.

### BRIEF DESCRIPTION OF DRAWINGS

FIG. 1 is a schematic diagram of a display panel according to an embodiment of this application;

FIG. 2 is a schematic diagram of a hardware structure of an electronic device according to an embodiment of this application;

FIG. 3 is a schematic diagram of a dynamic gray level node value according to an embodiment of this application;

FIG. 4 is a schematic flowchart of a brightness compensation method for a display panel according to an embodiment of this application;

FIG. 5 is a schematic diagram of delivering gray level node values and a DBV according to an embodiment of this application;

FIG. 6 is another schematic diagram of delivering gray level node values and a DBV according to an embodiment of this application;

FIG. 7 is an implementation flowchart of a method for adjusting a gray level node value according to an embodiment of this application;

FIG. 8 is a time sequence diagram of a software implementation of a brightness compensation method for a display panel according to an embodiment of this application; and

FIG. 9 is a schematic diagram of a structure of a system-on-chip according to an embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application. All other embodiments obtained by a person of ordinary skill in the art based on embodiments of this application without creative efforts shall fall within the protection scope of this application.

It should be noted that, the following terms such as “first” and “second” are merely intended for a purpose of description, and cannot be understood as an indication or implication of relative importance or an implication of a quantity of indicated technical features. Therefore, a feature defined by “first”, “second”, or the like may explicitly or implicitly include one or more such features. In addition, the terms “include” and “have” and any other variants thereof are intended to cover non-exclusive inclusions. For example, a process, a method, a system, a product, or a device that includes a series of steps or units is not limited to the listed steps or units, but optionally further includes an unlisted step or unit, or optionally further includes another inherent step or unit of the process, the method, the product, or the device.

Reference to “an embodiment”, “some embodiments”, or the like described in this specification means that one or more embodiments of this application include a specific feature, structure, or characteristic described with reference to the embodiment. Therefore, statements such as “in an embodiment”, “in some embodiments”, “in some other embodiments”, and “in other embodiments” that appear at different places in this specification do not necessarily mean reference to a same embodiment. Instead, the statements mean reference to “one or more but not all of embodiments”, unless otherwise specially emphasized in another manner.

In embodiments of this application, words such as “an example” or “for example” are used to represent giving an example, an illustration, or a description. Any embodiment or design solution described as “an example” or “for example” in embodiments of this application should not be explained as being more preferred or having more advantages than another embodiment or design solution. Exactly, use of the words such as “an example” or “for example” is intended to present a related concept in a specific manner.

For ease of understanding, terms involved in embodiments of this application are described.

(1) A gray level (gray level) is a brightness value of each pixel in a gray level image, and is usually represented by an integer of 0 to 255. In the gray level image, a gray level of each pixel indicates brightness of the pixel, and the gray level of the pixel is directly proportional to the brightness of the pixel. A larger gray level of the pixel indicates higher brightness of the pixel, and a smaller gray level of the pixel indicates lower brightness of the pixel. For example, if a gray level of a pixel is 0, it indicates that brightness of the pixel is very low, for example, the pixel has no brightness, and the pixel presents black. If a gray level of a pixel is 255, it indicates that brightness of the pixel is very high, and the pixel approaches or presents white. Gray levels between 0 and 255 indicate different gray levels. It should be noted that the gray level is applicable only to the gray level image. For a color image, each pixel usually includes color values of three channels: red, green, and blue. The color image needs to be converted into a gray level image to describe an image feature of the color image by using a gray level.

(2) mura is various trace phenomena caused by brightness unevenness of a display panel (panel). The display panel is switched to a black image and another low gray level image in a dark room, and then displayed images are seen from various different angles to determine whether there are traces in the displayed images, to determine whether there is mura on the display panel. This trace may be a horizontal stripe or 45-degree stripe, may be a straight cut square, may be a piece appearing in a corner, or may be an irregular trace.

(3) A tearing effect (Tearing Effect, TE) signal is a signal used to prevent a tearing problem during image refreshing in an image display process. The TE signal is generated by a display driver integrated circuit (display driver integrated circuit, DDIC), and an image frame may be refreshed based on the TE signal. When a next image frame is ready to be refreshed, a DDIC chip generates a TE signal, and synchronizes the TE signal to an application processor (application processor, AP), which may also be referred to as a host (host). Correspondingly, after monitoring a TE signal trigger edge, the AP sends data of the next image frame to the DDIC chip.

Currently, because an internal screen (also referred to as a display screen) of an electronic device has both a camera offset hole design and/or an ultra-high-frequency pulse width modulation (pulse width modulation, PWM) dimming characteristic, a mura effect of the display screen at low brightness is obviously deteriorated under a joint action of the camera offset hole design and ultra-high-frequency pulse width modulation. The display screen includes a display panel, and mura of the display panel herein is mura of the display panel in the display screen.

For ultra-high-frequency PWM dimming, a higher frequency indicates a larger quantity of pulses (pulse). An emission (emission, EM) control signal in the display panel may control lighting of pixels in the display panel. A larger quantity of pulses indicates a larger quantity of times the EM signal lights the pixels. The pixels are lit mainly by driving an expected current to display expected brightness on the screen. Therefore, a larger quantity of times of lighting the pixels is equivalent to a larger quantity of times of charging and discharging. In this case, compared with a small quantity of times of charging and discharging, for a large quantity of times of charging and discharging, it is more difficult to control the pixels to be charged to same brightness, and consequently brightness evenness of the display panel is poor.

The camera offset hole design causes mura on the display panel, and the ultra-high-frequency PWM dimming also causes mura on the display panel. Therefore, a mura effect of the display panel is obviously deteriorated under a joint action of the two factors.

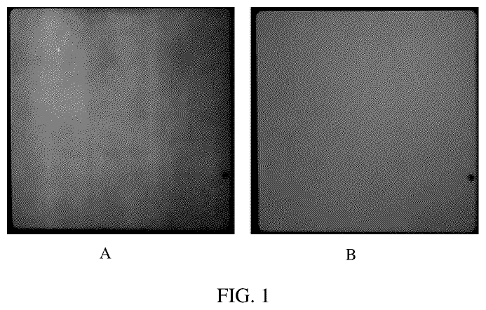

In a related technology, demura compensation may be performed on the display panel to eliminate a mura phenomenon of the display panel. demura is a method for obtaining brightness information of each pixel in the display panel to calculate a brightness compensation value, and adding the brightness compensation value to the pixel in the display panel to remove a brightness deviation of the pixel, so that brightness of the display panel becomes more even. As shown in FIG. 1, FIG. 1A is a schematic diagram of a display panel on which no demura compensation is performed, and brightness of the display panel is uneven. FIG. 1B is a schematic diagram of the display panel on which demura compensation is performed, and brightness of the display panel is even because mura is eliminated.

However, due to a difference in mura trends presented on the display panel at different brightness, a conventional demura solution of a fixed node provides a fixed brightness compensation value for the display panel at different brightness. Therefore, when brightness of the display panel changes, the conventional demura compensation solution cannot resolve a problem of a mura effect at current brightness.

Therefore, embodiments of this application provide a brightness compensation method for a display panel. An electronic device may divide display brightness values (Display Brightness Value, DBV) of the display panel into a plurality of brightness intervals in advance, correspondingly set different gray level node values for different brightness intervals, and set different corresponding brightness compensation values for gray level intervals including gray level node values in a same brightness interval. Brightness of the display panel is represented by a display brightness value of the display panel. The electronic device may calculate, for the display panel at a preset gray level based on at least two different pre-selected display brightness values by using a demura algorithm, brightness compensation values respectively corresponding to the different display brightness values. Therefore, after a display brightness value is adjusted, the electronic device may determine corresponding gray level node values based on a brightness interval in which a current display brightness value is located, in other words, determine brightness compensation values respectively corresponding to different gray level intervals including the corresponding gray level node values in the brightness interval. Then, the electronic device selects a corresponding brightness compensation value based on a gray level interval in which a current gray level is located, to perform brightness compensation on each pixel unit in the display panel, so that display unevenness of the display panel can be eliminated.

The electronic device in embodiments of this application may be an electronic device on which a display screen is installed. For example, the electronic device in embodiments of this application may be specifically a tablet computer, a mobile phone, a desktop, laptop, or handheld computer, a notebook computer, an ultra-mobile personal computer (ultra-mobile personal computer, UMPC), a netbook, a cellular phone, a personal digital assistant (personal digital assistant, PDA), an augmented reality (augmented reality, AR)\virtual reality (virtual reality, VR) device, a vehicle-mounted device, or the like. A specific form of the electronic device is not specially limited in embodiments of this application.

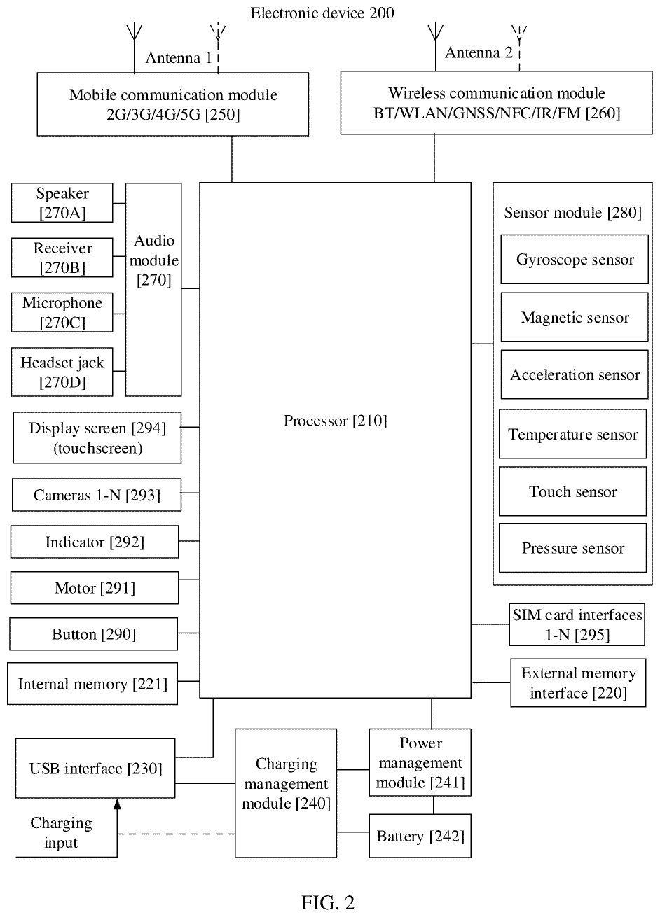

The brightness compensation method provided in embodiments of this application may be executed by a brightness compensation apparatus, and the execution apparatus may be an electronic device shown in FIG. 2. In addition, the execution apparatus may alternatively be a central processing unit (Central Processing Unit, CPU) of the electronic device, or a control module for brightness compensation in the electronic device. In embodiments of this application, the brightness compensation method provided in embodiments of this application is described by using an example in which the electronic device executes the brightness compensation method.

Implementations of embodiments of this application are described below in detail with reference to the accompanying drawings. A hardware structure of the electronic device (for example, an electronic device 200) is described by using an example in which the electronic device is a mobile phone. As shown in FIG. 2, the electronic device 200 may include a processor 210, an external memory interface 220, an internal memory 221, a universal serial bus (universal serial bus, USB) interface 230, a charging management module 240, a power management module 241, a battery 242, an antenna 1, an antenna 2, a mobile communication module 250, a wireless communication module 260, an audio module 270, a speaker 270A, a receiver 270B, a microphone 270C, a headset jack 270D, a sensor module 280, a button 290, a motor 291, an indicator 292, a camera 293, a display screen 294, a subscriber identification module (subscriber identification module, SIM) card interface 295, and the like.

The sensor module 280 may include sensors such as a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, and a bone conduction sensor.

It may be understood that the structure illustrated in this embodiment does not constitute a specific limitation on the electronic device 200. In some other embodiments, the electronic device 200 may include more or fewer components than those shown in the figure, may combine some components, may split some components, or may have a different component arrangement. The components shown in the figure may be implemented by hardware, software, or a combination of software and hardware.

The processor 210 may include one or more processing units. For example, the processor 210 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural-network processing unit (neural-network processing unit, NPU), and/or the like. Different processing units may be independent devices, or may be integrated into one or more processors.

The controller may be a nerve center and a command center of the electronic device 200. The controller may generate an operation control signal based on instruction operation code and a time sequence signal, to complete control of instruction reading and instruction execution.

The memory may be further disposed in the processor 210, and is configured to store instructions and data. In some embodiments, the memory in the processor 210 is a cache. The memory may store an instruction or data that is just used or cyclically used by the processor 210. If the processor 210 needs to reuse the instruction or the data, the processor 210 may directly invoke the instruction or the data from the memory. This avoids repeated access and reduces waiting time of the processor 210, thereby improving system efficiency.

In some embodiments, the processor 210 may include one or more interfaces. The interfaces may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

It may be understood that an interface connection relationship between modules that is illustrated in this embodiment is merely an example description, and does not constitute a structural limitation on the electronic device 200. In some other embodiments, the electronic device 200 may alternatively use different interface connection manners or a combination of a plurality of interface connection manners in the foregoing embodiment.

The charging management module 240 is configured to receive charging input from a charger. The charger may be a wireless charger, or may be a wired charger. In some embodiments of wired charging, the charging management module 240 may receive charging input from a wired charger through the USB interface 230. In some embodiments of wireless charging, the charging management module 240 may receive wireless charging input through a wireless charging coil of the electronic device 200. When charging the battery 242, the charging management module 240 may further supply power to the electronic device through the power management module 241.

The power management module 241 is configured to be connected to the battery 242, the charging management module 240, and the processor 210. The power management module 241 receives input from the battery 242 and/or the charging management module 240, and supplies power to the processor 210, the internal memory 221, an external memory, the display screen 294, the camera 293, the wireless communication module 260, and the like. The power management module 241 may be further configured to monitor parameters such as a battery capacity, a quantity of battery cycles, and a battery health status (leakage or impedance). In some other embodiments, the power management module 241 may alternatively be disposed in the processor 210. In some other embodiments, the power management module 241 and the charging management module 240 may alternatively be disposed in a same device.

A wireless communication function of the electronic device 200 may be implemented through the antenna 1, the antenna 2, the mobile communication module 250, the wireless communication module 260, the modem processor, the baseband processor, and the like.

The antenna 1 and the antenna 2 are configured to transmit and receive electromagnetic wave signals. Each antenna of the electronic device 200 may be configured to cover one or more communication bands. Different antennas may be further reused, to improve antenna utilization. For example, the antenna 1 may be reused as a diversity antenna of a wireless local area network. In some other embodiments, the antenna may be used in combination with a tuning switch.

The mobile communication module 250 may provide a wireless communication solution that is applied to the electronic device 200 and that includes 2G/3G/4G/5G or the like. The mobile communication module 250 may include at least one filter, switch, power amplifier, low noise amplifier (low noise amplifier, LNA), and the like. The mobile communication module 250 may receive an electromagnetic wave through the antenna 1, perform processing such as filtering and amplification on the received electromagnetic wave, and transmit a processed electromagnetic wave to the modem processor for demodulation.

The mobile communication module 250 may further amplify a signal obtained after the modem processor performs modulation, and convert the signal into an electromagnetic wave through the antenna 1, for radiation. In some embodiments, at least some functional modules of the mobile communication module 250 may be disposed in the processor 210. In some embodiments, at least some functional modules of the mobile communication module 250 may be disposed in a same device as at least some modules of the processor 210.

The modem processor may include a modulator and a demodulator. The modulator is configured to modulate a to-be-sent low-frequency baseband signal into a medium-high-frequency signal. The demodulator is configured to demodulate a received electromagnetic wave signal into a low-frequency baseband signal. Then, the demodulator transmits the low-frequency baseband signal obtained through demodulation to the baseband processor for processing. After the low-frequency baseband signal is processed by the baseband processor, a processed signal is transferred to the application processor. The application processor outputs a sound signal through an audio device (not limited to the speaker 270A, the receiver 270B, or the like), or displays an image or a video through the display screen 294. In some embodiments, the modem processor may be an independent device. In some other embodiments, the modem processor may be independent of the processor 210, and is disposed in a same device as the mobile communication module 250 or another functional module.

The wireless communication module 260 may provide a wireless communication solution that is applied to the electronic device 300 and that includes a wireless local area network (wireless local area networks, WLAN) (for example, a wireless fidelity (wireless fidelity, Wi-Fi) network), Bluetooth (bluetooth, BT), a global navigation satellite system (global navigation satellite system, GNSS), frequency modulation (frequency modulation, FM), a near field communication (near field communication, NFC) technology, an infrared (infrared, IR) technology, or the like.

The wireless communication module 260 may be one or more devices integrating at least one communication processing module. The wireless communication module 260 receives an electromagnetic wave through the antenna 2, performs frequency modulation and filtering processing on an electromagnetic wave signal, and sends a processed signal to the processor 210. The wireless communication module 260 may further receive a to-be-sent signal from the processor 210, perform frequency modulation and amplification on the signal, and convert a modulated and amplified signal into an electromagnetic wave through the antenna 2, for radiation.

In some embodiments, in the electronic device 200, the antenna 1 is coupled to the mobile communication module 250, and the antenna 2 is coupled to the wireless communication module 260, so that the electronic device 200 can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (beidou navigation satellite system, BDS), a quasi-zenith satellite system (quasi-zenith satellite system, QZSS), and/or a satellite based augmentation system (satellite based augmentation systems, SBAS).

The electronic device 200 implements a display function through the GPU, the display screen 294, the application processor, and the like. The GPU is a microprocessor for image processing, and is connected to the display screen 294 and the application processor. The GPU is configured to perform mathematical and geometric computation, for image rendering. The processor 210 may include one or more GPUs, and the GPUs execute program instructions to generate or change display information.

The display screen 294 is configured to display an image, a video, or the like. The display screen 294 includes a display panel. The display panel may be a liquid crystal display (liquid crystal display, LCD), an organic light-emitting diode (organic light-emitting diode, OLED), an active-matrix organic light emitting diode or an active-matrix organic light emitting diode (active-matrix organic light emitting diode, AMOLED), a flex light-emitting diode (flex light-emitting diode, FLED), a Miniled, a MicroLed, a Micro-oLed, a quantum dot light emitting diode (quantum dot light emitting diodes, QLED), or the like.

The electronic device 200 may implement a photographing function through the ISP, the camera 293, the video codec, the GPU, the display screen 294, the application processor, and the like.

The ISP is configured to process data fed back by the camera 293. For example, during photographing, a shutter is opened, and light is transferred to a photosensitive element of the camera through a lens. An optical signal is converted into an electrical signal. The photosensitive element of the camera transfers the electrical signal to the ISP for processing, to convert the electrical signal into an image visible to naked eyes. The ISP may further perform algorithm optimization on noise, brightness, and complexion of the image. The ISP may further optimize parameters such as exposure and color temperature of a photographing scene. In some embodiments, the ISP may be disposed in the camera 293.

The camera 293 is configured to capture a static image or a video. An optical image of an object is generated through the lens and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transfers the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 200 may include one or N cameras 293, where N is a positive integer greater than 1.

In this embodiment of this application, a hole may be opened at a position deviating from a center line in the display panel, to place the camera.

The digital signal processor is configured to process a digital signal, and may further process another digital signal in addition to a digital image signal. For example, when the electronic device 200 performs frequency selection, the digital signal processor is configured to perform a Fourier transform or the like on frequency energy.

The video codec is configured to compress or decompress a digital video. The electronic device 200 can support one or more types of video codecs. In this way, the electronic device 200 can play or record videos in a plurality of encoding formats, for example, a moving picture experts group (moving picture experts group, MPEG) 1, an MPEG 2, an MPEG 3, and an MPEG 4.

The NPU is a neural-network (neural-network, NN) computing processor. The NPU quickly processes input information by referring to a biological neural network structure, for example, by referring to a transferring mode between human brain neurons, and may further continuously perform self-learning. Applications such as intelligent recognition of the electronic device 200, for example, image recognition, face recognition, speech recognition, and text understanding, may be implemented through the NPU.

The external memory interface 220 may be configured to be connected to an external memory card, for example, a Micro SD card, to extend a storage capability of the electronic device 200. The external memory card communicates with the processor 210 through the external memory interface 220, to implement a data storage function. For example, files such as music and a video are stored in the external memory card.

The internal memory 221 may be configured to store computer-executable program code. The executable program code includes instructions. The processor 210 runs the instructions stored in the internal memory 221, to perform various function applications and data processing of the electronic device 200. For example, in this embodiment of this application, the processor 210 may execute the instructions stored in the internal memory 221. The internal memory 221 may include a program storage region and a data storage region.

The program storage region may store an operating system, an application required by at least one function (for example, a sound playing function or an image playing function), and the like. The data storage region may store data (such as audio data and an address book) created in a process of using the electronic device 200, and the like. In addition, the internal memory 221 may include a high-speed random access memory, and may further include a nonvolatile memory, for example, at least one disk storage device, a flash storage device, or a universal flash storage (universal flash storage, UFS).

The electronic device 200 may implement an audio function, for example, music playing or recording, through the audio module 270, the speaker 270A, the receiver 270B, the microphone 270C, the headset jack 270D, the application processor, and the like.

The touch sensor is also referred to as a “touch panel”. The touch sensor may be disposed in the display screen 294. The touch sensor and the display screen 294 constitute a touchscreen, also referred to as a “touch control screen”. The touch sensor is configured to detect a touch operation performed on or near the touch sensor. The touch sensor may transfer the detected touch operation to the application processor, to determine a type of a touch event. Visual output related to the touch operation may be provided through the display screen 294. In some other embodiments, the touch sensor may alternatively be disposed on a surface of the electronic device 200 at a position different from that of the display screen 294.

In this embodiment of this application, the electronic device 200 may detect, through the touch sensor, a touch operation input by a user on the touchscreen, and collect one or more of a touch position, a touch area, a touch direction, touch time, and the like of the touch operation on the touchscreen. In some embodiments, the electronic device 200 may determine the touch position of the touch operation on the touchscreen through a combination of the touch sensor and the pressure sensor.

The button 290 includes a power-on button, a volume button, and the like. The button 290 may be a mechanical button, or may be a touch button. The electronic device 200 may receive button input, and generate button signal input related to user settings and function control of the electronic device 200.

The motor 291 may generate a vibration prompt. The motor 291 may be configured to provide an incoming-call vibration prompt, and may be further configured to provide touch vibration feedback. For example, touch operations applied to different applications (for example, photographing and audio playback) may correspond to different vibration feedback effects. The motor 291 may also correspond to different vibration feedback effects for touch operations applied to different regions of the display screen 294. Different application scenarios (for example, a time reminder, information receiving, an alarm clock, and a game) may also correspond to different vibration feedback effects. A touch vibration feedback effect may be further customized.

The indicator 292 may be an indicator light, and may be configured to indicate a charging status or a power change, or may be configured to indicate a message, a missed call, a notification, or the like. The SIM card interface 295 is configured to be connected to a SIM card. The SIM card may be inserted into the SIM card interface 295 or pulled out from the SIM card interface 295, to implement contact with or separation from the electronic device 200. The electronic device 200 may support one or N SIM card interfaces, where N is a positive integer greater than 1. The SIM card interface 295 may support a Nano SIM card, a Micro SIM card, an SIM card, and the like.

All methods in the following embodiments can be implemented in the electronic device 200 having the foregoing hardware structure.

In embodiments of this application, specific steps 1-4 of separately setting corresponding brightness compensation values for different gray level intervals of different brightness intervals of a display panel are first described. The brightness compensation value herein may be referred to as mura compensation data. The brightness compensation value may be used to compensate a brightness value of each pixel unit in the display panel when the display panel presents a mura image. The brightness compensation value may be calculated by using a demura compensation algorithm.

It may be understood that the display panel presents different mura at different gray levels, and the display panel also presents different mura at different display brightness values (DBV).

Step 1. First, an electronic device selects at least one group of mura images from mura images presented on the display panel at display brightness values. One group of mura images includes a plurality of mura images with a relatively large difference, one mura image in the plurality of mura images corresponds to one display brightness value, and the plurality of mura images may include two mura images, for example, a first mura image and a second mura image, or may include more than two mura images, for example, three mura images or four mura images.

In some embodiments, a quantity of selected display brightness values may not be limited, but it needs to be ensured that mura images presented on the display panel at selected display brightness values are obviously different. In some other embodiments, because of a limitation of storage space of the electronic device, to reduce pressure of the storage space, a quantity threshold may be preset, and a plurality of mura images with a relatively large difference and whose quantity is the preset quantity threshold are selected to subsequently generate a corresponding compensation solution. Generally, mura images with a relatively large difference at two display brightness values are selected to generate a corresponding compensation solution.

In this application, the relatively large difference may include a relatively large difference between image information of the mura images. The image information may include shapes of the mura images, sizes of the mura images, colors of the mura images, and the like. The plurality of mura images with the relatively large difference may be replaced with a description that difference information between the plurality of mura images is greater than a preset difference range. The difference information may include a difference between any one or more of shapes of the mura images, sizes of the mura images, or colors of the mura images. The preset difference range may be set based on a requirement and is not limited. When the difference information is greater than the preset difference range, it indicates a relatively large difference. When the difference information is less than the preset difference range, it indicates a relatively small difference.

In an example, generally, ultra-high-frequency PWM dimming is mainly dimming for low brightness. Therefore, mura on the display panel due to the ultra-high-frequency PWM dimming is actually mura on the display panel at low brightness. To better eliminate mura on the display panel at low brightness, when display brightness values for generating a compensation solution are selected above, selection is usually first performed from a low brightness range. In other words, it may be understood that the foregoing selected group of mura images includes at least one mura image presented at low brightness. Optionally, a difference between a mura image presented at low brightness and a mura image presented at high brightness is usually relatively large. After a display brightness value (set to a first display brightness value) is selected from the low brightness range, and a mura image corresponding to the first display brightness value is obtained, a display brightness value (set to a second display brightness value) may be selected from a high brightness range, and a mura image corresponding to the second display brightness value may be obtained. Then, the mura image corresponding to the first display brightness value and the mura image corresponding to the second display brightness value may be combined to obtain a group of mura images with a relatively large difference.

In this embodiment of this application, the low brightness range may be referred to as a low brightness interval, and the low brightness range may include a plurality of low display brightness values. The high brightness range may be referred to as a high brightness interval, and the high brightness range may include a plurality of high brightness display values. The low brightness range and the high brightness range may be adjusted based on an actual requirement and are not limited. Selecting a display brightness value from the low brightness range may include randomly selecting one or more display brightness values from the low brightness range, and selecting a display brightness value from the high brightness range may include randomly selecting one or more display brightness values from the high brightness range. Alternatively, a quantity (which may be referred to as a preset quantity) may be preset. Selecting a display brightness value from the low brightness range may include selecting a preset quantity of relatively low display brightness values from the low brightness range, and selecting a display brightness value from the high brightness range may include selecting a preset quantity of relatively high display brightness values from the high brightness range.

For example, a mura image corresponding to a lowest display brightness value and a mura image corresponding to a highest display brightness value may be used as a group of mura images. For example, for 2 nits-600 nits, 2 nits is a lowest display brightness value, and 600 nits is a highest display brightness value. In this case, a mura image presented on the display panel when a DBV is 2 nits and a mura image presented on the display panel when a DBV is 600 nits may be used as a group of mura images with a relatively large difference.

In another example, mura images presented at display brightness values are traversed to search for a plurality of mura images with a relatively large difference (alternatively referred to as a plurality of mura images with a relatively large difference between image information), and the plurality of mura images with the relatively large difference are used as a group of mura images.

For example, the pixel unit in the display panel includes a plurality of pixels. When efficiency of a red pixel is higher than efficiency of a green pixel and efficiency of a blue pixel in the pixel unit, the whole pixel unit is reddish. When efficiency of a green pixel is higher than efficiency of a red pixel and efficiency of a blue pixel in the pixel unit, the whole pixel unit is greenish. For example, the image information includes colors of the mura images, and difference information includes a difference between the colors of the plurality of mura images. The mura images presented at the display brightness values are traversed, and it is found that when a DBV is 2 nits, a whole pixel unit in an upper-part region of the display panel is reddish, and a whole pixel unit in a lower-part region of the display panel is greenish; and when a DBV is 600 nits, the whole pixel unit in the upper-part region of the display panel is greenish, and the whole pixel unit in the lower-part region of the display panel is reddish. In other words, there is a relatively large difference between colors presented in a same region of the display panel at different DBVs, and difference information between a mura image presented on the display panel when the DBV is 2 nits and a mura image presented on the display panel when the DBV is 600 nits is greater than a preset difference range. Therefore, it may be considered that the difference information between the mura image presented on the display panel when the DBV is 2 nits and the mura image presented on the display panel when the DBV is 600 nits is greater than the foregoing preset difference range. The foregoing difference information between the display colors of the pixel unit is only an example. Alternatively, for example, difference information between shapes or sizes of the mura images may be used.

Step 2. Then, for any group of mura images, a gray level of each mura image in the group of mura images is adjusted, and a mura image obtained after gray level adjustment is photographed to obtain a mura image corresponding to a gray level at a display brightness value. Further, the mura image obtained through photographing is stored.

In this embodiment of this application, adjusting the gray level of each mura image in the group of mura images may include adjusting the gray level of the mura image to a preset gray level. The preset gray level may be set based on a requirement, for example, may be one or more preset gray levels. It should be understood that, when there is one preset gray level, a mura image corresponding to the gray level at the display brightness value may be obtained through photographing. When there are a plurality of preset gray levels, mura images corresponding to the plurality of gray levels at the display brightness value may be obtained through photographing.

Optionally, the preset gray level may be a low gray level, or the gray level is less than a preset gray level threshold. The preset gray level threshold in this embodiment of this application may be adjusted based on an actual requirement. For example, the preset gray level may include a low gray level in gray levels 0-255, so that efficiency of selecting to-be-compensated gray levels at different display brightness values can be improved. Alternatively, the preset gray level may include all of the gray levels 0-255. This is not limited.

For example, when a mura image presented on the display panel when a DBV is 2 nits and a mura image presented on the display panel when a DBV is 600 nits are used as a group of mura images with a relatively large difference, a DBV value of the display panel may be adjusted to 600 nits. At 600 nits, gray levels are adjusted, and mura images at a preset gray level are separately photographed. Gray levels such as 16, 32, and 64 may be selected as preset gray levels. After the gray levels are adjusted to the corresponding gray level, mura images presented in this case are photographed. After photographing of the mura images at 600 nits is completed, similarly, the DBV value of the display panel is adjusted to 2 nits, and mura images at a preset gray level are separately photographed. For example, preset gray levels may alternatively be gray levels 32 and 64.

Step 3. Further, for mura images that are obtained through photographing and that correspond to gray levels at any display brightness value, a gray level node value corresponding to each display brightness value is determined, and a brightness compensation solution corresponding to a target gray level node value at the display brightness value is determined.

For example, in step 2, a mura image corresponding to one gray level at the display brightness value is obtained through photographing, or mura images corresponding to a plurality of gray levels at the display brightness value are obtained through photographing. When the mura image corresponding to the gray level exists, the gray level is a gray level node value corresponding to the display brightness value. When the mura images corresponding to the plurality of gray levels exist, a mura image corresponding to any gray level is checked, and one or more gray level node values corresponding to the display brightness value are determined from the plurality of gray levels based on difference information between the mura images corresponding to the gray levels.

In this embodiment of this application, the gray level node value may be referred to as a demarcation point. The gray level node value herein indicates that difference information between a mura image presented on the display panel when a gray level is less than the gray level node value and a mura image presented on display panel when a gray level is greater than the gray level node value is greater than a preset difference range.

For example, there is one preset gray level, for example, a gray level 32. A mura image presented on the display panel at the gray level 32 at 2 nits and a mura image presented on the display panel at the gray level 32 at 600 nits are obtained through photographing. The gray level 32 may be selected as a gray level node value of 2 nits, and the gray level 32 may be selected as a gray level node value of 600 nits.

For another example, there are a plurality of preset gray levels, for example, gray levels 6 and 60. mura images presented on the display panel at the gray level 6 and the gray level 60 at 2 nits and mura images presented on the display panel at the gray level 6 and the gray level 60 at 600 nits are obtained through photographing. At 2 nits, difference information between a mura image presented when a gray level is less than 60 and a mura image presented when a gray level is greater than 60 is greater than the foregoing preset difference range, and it is determined that a gray level node value at 2 nits is the gray level 60. At 600 nits, difference information between a mura image presented when a gray level is less than 6 and a mura image presented when a gray level is greater than 6 is greater than the foregoing preset difference range, and it is determined that a gray level node value at 600 nits is the gray level 6.

In this embodiment of this application, when a display brightness value corresponds to a plurality of gray level node values, a target gray level may be any gray level node value in the plurality of gray level node values corresponding to the display brightness value. Optionally, a target gray level may be a gray level node value corresponding to a mura image with a most severe mura phenomenon in mura images corresponding to the plurality of gray level node values corresponding to the display brightness value. The brightness compensation solution may be referred to as a demura compensation solution, and the brightness compensation solution is a brightness compensation value that is of each pixel unit in the display panel and that is calculated by using a demura compensation algorithm.

For example, the brightness compensation solution corresponding to the target gray level node value at the display brightness value may be determined according to the following method: A target brightness value of each pixel unit included in the display panel is set. An actual brightness value that is of each pixel unit included in the display panel and that is obtained when the display brightness value and the target gray level node value are used for display is obtained. For each pixel unit, a difference (alternatively referred to as an offset (offset)) between an actual pixel value of the pixel unit and the target brightness value is calculated to obtain a brightness compensation value of the pixel unit. Then, the brightness compensation value of each pixel unit included in the display panel is used as the brightness compensation value corresponding to the target gray level node value at the display brightness value.

In this embodiment of this application, for ease of description, the brightness compensation solution corresponding to the target gray level node value at the display brightness value may be replaced with a description of a demura compensation solution generated for a mura image at the display brightness value. Different demura compensation solutions are generated for mura images at different brightness display values, and may be distinguished by using different names. For example, a demura compensation solution generated for a mura image at 2 nits may be referred to as a first demura compensation solution, and a demura compensation solution generated for a mura image at 600 nits may be referred to as a second demura compensation solution. Specifically, each pixel unit of the display panel corresponds to one target brightness value at a gray level 32 at 2 nits, and a brightness compensation value of each pixel unit is calculated based on a difference between an actual brightness value of each pixel unit in this case and the target brightness value. A corresponding demura compensation solution (second compensation solution) is generated for a mura image presented on the display panel at the gray level 32 at 600 nits.

Optionally, the electronic device may store, based on a position of each pixel unit in the display panel, the brightness compensation value corresponding to each pixel unit. Alternatively, the electronic device may generate a compensation image based on the brightness compensation value of each pixel unit, and then may burn generated compensation images respectively corresponding to the foregoing two display brightness values into a random access memory (Random Access Memory, RAM) of an integrated circuit (Integrated Circuit Chip, IC) chip.

Step 4. Display brightness values may be divided into a plurality of brightness intervals based on mura images presented on the display panel at different display brightness values. Then, for each brightness interval in the plurality of brightness intervals, a gray level node value corresponding to each brightness interval is determined, a plurality of gray level intervals are obtained based on the gray level node value corresponding to the brightness interval, and a brightness compensation solution (alternatively referred to as a compensation solution or a demura compensation solution) corresponding to each brightness interval is determined. A gray level node value corresponding to each display brightness value is obtained according to step 3.

In this embodiment of this application, the brightness interval includes a plurality of display brightness values. Difference information between mura images displayed on the display panel at display brightness values in a same brightness interval falls within a preset difference range. In other words, the mura images displayed at the display brightness values in the same brightness interval are basically the same, and have no relatively large difference. The preset difference range may be set based on a requirement and is not limited. Same or close mura images may correspond to a same gray level node value. Therefore, different display brightness values in a same brightness interval correspond to a same gray level node value. In this case, the gray level node value corresponding to the different display brightness values in the brightness interval may be referred to as a gray level node value corresponding to the brightness interval.

In this embodiment of this application, a gray level node value corresponding to display brightness values included in a same brightness interval may be used as a demarcation point to divide a preset gray level range to obtain different gray level intervals. Optionally, the gray level range may be a preset gray level range 0-255. Specifically, the gray level range 0-255 may be divided in ascending order of the gray level range 0-255 by using the gray level node value as the demarcation point, to obtain a plurality of gray level intervals. For example, gray level node values corresponding to a brightness interval are 60 and 80. In this case, gray level intervals including the gray level node values are 0-60, 61-79, and 80-255.

In this application, for any brightness interval, a difference between image information of a mura image corresponding to a first gray level interval corresponding to the brightness interval and image information of a mura image that corresponds to a target gray level node value of each display brightness value and that is obtained in step 3 is compared, and a brightness compensation value corresponding to a target gray level node value of a display brightness value with a smallest difference is used as a brightness compensation value of the first gray level interval. For example, a first brightness compensation solution corresponding to a target gray level node value of a first display brightness value and a second brightness compensation solution corresponding to a target gray level node value of a second display brightness value are obtained in step 3. In this case, a difference (which may be referred to as a first difference) between the image information of the mura image corresponding to the first gray level interval and image information of a mura image corresponding to the target gray level node value of the first display brightness value and a difference (which may be referred to as a second difference) between the image information of the mura image corresponding to the first gray level interval and image information of a mura image corresponding to the target gray level of the second display brightness value may be compared. If the first difference is greater than the second difference, a brightness compensation value indicated by the second brightness compensation solution is used as the brightness compensation value corresponding to the first gray level interval. If the first difference is less than the second difference, a brightness compensation value indicated by the first brightness compensation solution is used as the brightness compensation value of the first gray level interval.

The foregoing process may be understood as follows: When the corresponding brightness compensation value is selected for the first gray level interval, the mura image presented on the display panel in the first gray level interval is separately compared with a mura image presented on the display panel at a preset gray level of the first display brightness value and a mura image presented on the display panel at a preset gray level of the second display brightness value. If the mura image presented on the display panel in the first gray level interval is closer to the mura image presented on the display panel at the preset gray level of the first display brightness value, the brightness compensation value corresponding to the first gray level interval is the brightness compensation value corresponding to the first compensation solution. If the mura image presented on the display panel in the first gray level interval is closer to the mura image presented on the display panel at the preset gray level of the second display brightness value, the brightness compensation value corresponding to the first gray level interval is the brightness compensation value corresponding to the second compensation solution.

The first gray level interval may include a gray level interval including a first gray level node value and a smallest gray level in a total gray level range, and a gray level interval including a second gray level node value and a largest gray level in the total gray level range. The first gray level is less than the second gray level, and the first gray level interval may include one or more gray level intervals. For ease of description, when one gray level interval is included, the gray level interval may be referred to as a first gray level interval. When a plurality of gray level intervals are included, for example, two gray level intervals are included, the two gray level intervals may be respectively referred to as a first gray level interval and a second gray level interval. This is not limited.

Further, for a gray level interval (which may be referred to as a third gray level interval) that corresponds to a same brightness interval and that is other than a first gray level interval, a fitting function related to a gray level and a brightness compensation value may be obtained based on a brightness compensation value of the first gray level interval, gray levels of the first gray level interval, a brightness compensation value of a second gray level interval, and gray levels of the second gray level interval, to calculate a brightness compensation value (a third compensation solution) of each pixel unit in the display panel in the third gray level interval.

Therefore, in the foregoing manner, matching brightness compensation values may be sequentially selected for the display panel in different gray level intervals in a same brightness interval. By analogy, matching brightness compensation values are sequentially selected for the display panel in different gray level intervals in brightness intervals.

For example, gray level node values corresponding to a brightness interval are 60 and 80. In this case, gray level intervals including the gray level node values are 0-60, 61-79, and 80-255. The three gray level intervals respectively correspond to different brightness compensation solutions. It is assumed that a gray level interval with a smallest gray level is a first gray level interval, a gray level interval with a largest gray level is a second gray level interval, and a middle gray level interval is a third gray level interval. If a gray level of a to-be-displayed image of the display panel is in the first gray level interval, a first compensation solution for the display panel at low brightness may be selected. If a gray level of a to-be-displayed image of the display panel is in the third gray level interval, a first compensation solution for the display panel at high brightness may be selected.

In this embodiment of this application, a smaller display brightness value in the brightness interval indicates a larger proportion of the first gray level interval corresponding to the brightness interval in a total gray level range, and a smaller display brightness value in the brightness interval indicates a smaller proportion of the second gray level interval corresponding to the brightness interval in the total gray level range.

For example, a DBV is 2 nits. Because a compensation image corresponding to the DBV of 2 nits is generated for brightness compensation for a low-brightness mura image, a smaller DBV value of the display panel indicates that brightness compensation for a mura image more meets an effect of the compensation image corresponding to the DBV of 2 nits. Therefore, a smaller DBV value in the brightness interval indicates that brightness compensation is performed on the display panel in a larger gray level range by using the compensation image corresponding to the DBV of 2 nits. In other words, a proportion of a selected gray level interval of the compensation image corresponding to the DBV of 2 nits in the total gray level range is larger. A larger DBV value in the brightness interval indicates that brightness compensation is performed on the display panel in a smaller gray level range by using the compensation image corresponding to the DBV of 2 nits. In other words, a proportion of a selected gray level interval of the compensation image corresponding to the DBV of 2 nits in the total gray level range is smaller. Therefore, the gray level interval corresponding to the first compensation solution includes the gray level node and the smallest gray level in the total gray level range. In a brightness interval corresponding to a larger display brightness value, a gray level node value corresponding to the first compensation solution is smaller. For example, it is assumed that a display brightness value in a first brightness interval is less than a display brightness value in a second brightness interval. If a gray level node value corresponding to the first compensation solution in the first brightness interval is 60, a gray level node value corresponding to the first compensation solution in the second brightness interval may be 20. It may be learned that, a proportion of a first gray level interval 0-60 in the total gray level range is greater than a proportion of a second gray level interval 0-200 in the total gray level range.

For example, a DBV is 600 nits. Because a compensation image corresponding to the DBV of 600 nits is generated for brightness compensation for a high-brightness mura image, a larger DBV value of the display panel indicates that brightness compensation for a mura image more meets an effect of the compensation image corresponding to the DBV of 600 nits. Therefore, a larger DBV brightness value in the brightness interval indicates that brightness compensation is performed on the display panel in a larger gray level range by using the compensation image corresponding to the DBV of 600 nits. In other words, a proportion of a selected gray level interval of the compensation image corresponding to the DBV of 600 nits in the total gray level range is larger. Therefore, the gray level interval corresponding to the second compensation solution includes the gray level node and the largest gray level in the total gray level range. In a brightness interval corresponding to a larger display brightness value, a gray level node value corresponding to the second compensation solution is smaller. For example, it is assumed that a display brightness value in a first brightness interval is less than a display brightness value in a second brightness interval. If a gray level node value corresponding to the second compensation solution in the first brightness interval is 80, a gray level node value corresponding to the second compensation solution in the second brightness interval may be 32. It may be learned that, a proportion of a second gray level interval 80-255 in the total gray level range is less than a proportion of a second gray level interval 32-255 in the total gray level range.

It may be understood that, in the foregoing steps 1-4, the calculation for the brightness compensation solution, the setting of gray level node values corresponding to different brightness intervals, and the setting of brightness compensation solutions corresponding to different gray level intervals are all factory settings of the electronic device.

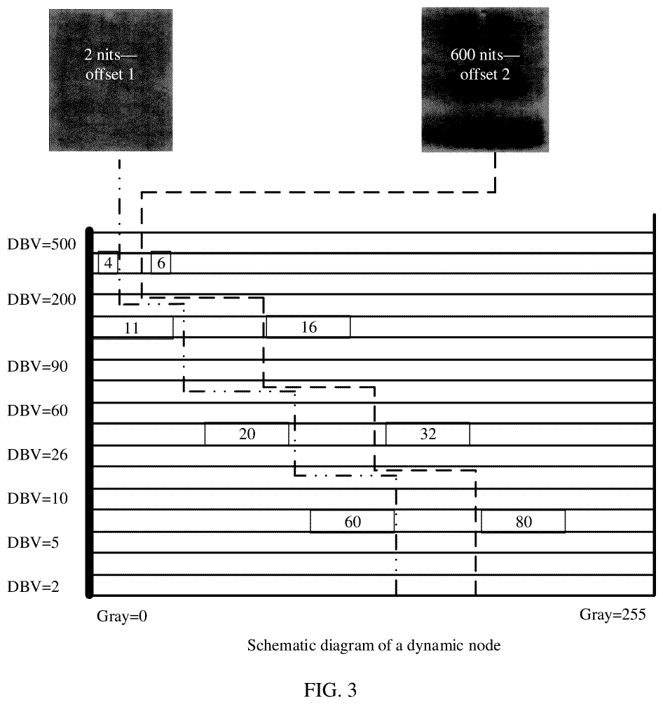

Refer to FIG. 3. FIG. 3 is a schematic diagram of a dynamic gray level node according to an embodiment of this application. As shown in FIG. 3, an electronic device chooses to first perform demura compensation on mura presented on a display panel at 2 nits and 600 nits. The electronic device photographs mura presented on the display panel at preset gray levels when DBV values are respectively 2 nits and 600 nits, and a mura compensation value of each pixel unit in the display panel is calculated by using a demura algorithm. Two compensation images may be generated based on the mura compensation value of each pixel unit in the display panel, and are set to demura maps, namely, an offset 1 and an offset 2 in the figure. The offset 1 corresponds to a compensation image of the display panel at 2 nits, and the offset 2 corresponds to a compensation image of the display panel at 600 nits. A vertical axis is a display brightness value DBV, and a horizontal axis is a gray level.

As shown in FIG. 3, display brightness values of the display panel may be divided into four brightness intervals. A first brightness interval, a second brightness interval, a third brightness interval, and a fourth brightness interval are set in ascending order of the display brightness values included in the brightness intervals. In the first brightness interval, a gray level node value corresponding to 2 nits is 60, and a gray level node value corresponding to 600 nits is 80. In the second brightness interval, a gray level node value corresponding to 2 nits is 20, and a gray level node value corresponding to 600 nits is 32. In the third brightness interval, a gray level node value corresponding to 2 nits is 11, and a gray level node value corresponding to 600 nits is 16. In the fourth brightness interval, a gray level node value corresponding to 2 nits is 4, and a gray level node value corresponding to 600 nits is 6. To be specific, when it is detected that a display brightness value is in the first brightness interval, if a calculated gray level is not greater than 60 (set to a first gray level interval) in this case, an IC of the electronic device selects a compensation solution corresponding to the offset 1 to perform brightness compensation on the display panel. If a calculated gray level is not less than 80 (set to a second gray level interval) in this case, the IC of the electronic device selects a compensation solution corresponding to the offset 2 to perform brightness compensation on the display panel.

If a gray level is between two gray level node values, for example, the gray level is greater than 60 and less than 80 (set to a third gray level interval) in the first brightness interval, the electronic device may obtain, based on a brightness compensation value of the first gray level interval, gray levels of the first gray level interval, a brightness compensation value of the second gray level interval, and gray levels of the second gray level interval, a fitting function related to a gray level and a brightness compensation value, so that a brightness compensation value of each pixel unit in the display panel in the third gray level interval can be calculated. Therefore, when it is detected that a display brightness value is in the first brightness interval, if a calculated gray level is greater than 60 and less than 80 in this case, the IC of the electronic device selects a fitted brightness compensation value solution (a third compensation solution) to perform brightness compensation on each pixel unit in the display panel.

It may be learned from FIG. 3 that, for the offset 1, a smaller DBV value indicates a larger proportion of a corresponding gray level interval in gray levels; and for the offset 2, a larger DBV value indicates a larger proportion of a corresponding gray level interval in the gray levels. It may be understood that the brightness interval division and the corresponding gray level node values herein are merely examples.

Further, mapping relationships between brightness intervals and corresponding gray level node values, and a brightness compensation solution (alternatively referred to as a compensation solution or a demura compensation solution) corresponding to each gray level interval may be pre-stored in the electronic device, for example, stored in a storage module of the electronic device.

The foregoing describes a process of generating and storing a compensation solution of a mura image corresponding to a gray level at a display brightness value. In this embodiment of this application, after the brightness intervals and the corresponding gray level node values are preset, when an image is subsequently displayed on the display panel, a corresponding compensation solution may be selected based on a display brightness value and a gray level, to perform brightness compensation on the display panel and then perform display, thereby eliminating a display brightness unevenness phenomenon of the display panel. The storage module in the electronic device may store the mapping relationships between the preset brightness intervals and corresponding gray level node values. When a current display brightness value of the display panel changes across intervals, the electronic device may select a corresponding gray level node value from the mapping relationships based on a current brightness interval, and then write the gray level node value into a RAM. Therefore, an IC chip can select a corresponding brightness compensation solution based on a gray level interval in which a gray level of a to-be-displayed image is located. The gray level interval herein is obtained through division based on the new written gray level node value, and brightness compensation solutions have been stored in the RAM.

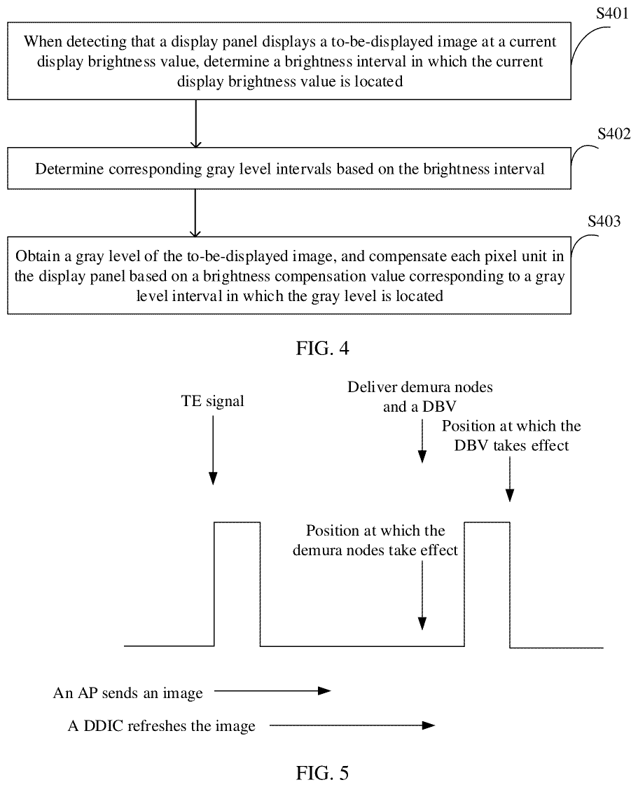

Refer to FIG. 4. FIG. 4 is an implementation flowchart of a brightness compensation method for a display panel according to an embodiment of this application. As shown in FIG. 4, the brightness compensation method may include S401-S403.

S401. When detecting that the display panel performs display at a current display brightness value, the electronic device determines a brightness interval in which the current display brightness value is located.

In this embodiment of this application, the display brightness value may be understood as backlight brightness of the display panel of the electronic device, in other words, the backlight brightness of the display panel may be represented by the display brightness value DBV. The backlight brightness of the display panel of the electronic device may be adjusted, for example, adjusted from a first display brightness value to a second display brightness value.

The current display brightness value in this application may be an initialized display brightness value, or may be an adjusted display brightness value, for example, may be a display brightness value obtained by adjusting a previous display brightness value. When the current display brightness value is an adjusted display brightness value, the electronic device may adjust a display brightness value of the display panel in response to an adjustment instruction of a user for the display brightness value. Alternatively, when ambient brightness of the electronic device changes, the electronic device automatically adjusts a display brightness value of the display panel. For example, when the user walks from the indoor to the outdoor, ambient brightness of the electronic device held by the user changes, and the electronic device triggers an adjustment procedure for a display brightness value.

Optionally, when the current display brightness value is an adjusted display brightness value, after detecting that the display panel performs display at the current display brightness value, the electronic device detects whether the display brightness value changes across intervals. For example, it is assumed that the electronic device divides display brightness values into a first brightness interval (1 nit-240 nits), a second brightness interval (241 nits-666 nits), and a third brightness interval (667 nits-1284 nits) based on mura images presented on the display panel at different display brightness values. Specifically, for the brightness interval division, refer to descriptions in the foregoing step 4. Details are not described. If it is detected that the current display brightness value of the display panel changes from 200 nits to 400 nits, the display brightness value of the display panel changes across intervals, to be specific, changes from the first brightness interval to the second brightness interval.

Then, the electronic device determines the brightness interval in which the current display brightness value is located, and performs step S402.

S402. The electronic device determines corresponding gray level intervals based on the brightness interval.

In this embodiment of this application, because gray level node values corresponding to brightness intervals have been preset, gray level intervals can be determined based on the gray level node values. Specifically, the gray level intervals corresponding to the brightness interval may be determined with reference to the method described in the foregoing step 4. For example, it is assumed that gray level node values corresponding to the first brightness interval may be 30 and 72. In this case, the gray level node values may constitute corresponding gray level intervals 0-30 (a gray level interval 1), 31-71 (a gray level interval 2), and 72-255 (a gray level interval 3). It is assumed that gray level node values corresponding to the second brightness interval may be 24 and 31. In this case, the gray level node values may constitute corresponding gray level intervals 0-24 (a gray level interval 1), 25-30 (a gray level interval 2), and 31-255 (a gray level interval 3). It is assumed that gray level node values corresponding to the third brightness interval may be 5 and 24. In this case, the gray level node values may constitute corresponding gray level intervals 0-5 (a gray level interval 1), 6-23 (a gray level interval 2), and 24-255 (a gray level interval 3).

The gray level interval 1 corresponds to a first compensation solution, the gray level interval 3 corresponds to a second compensation solution, and the gray level interval 2 corresponds to a third compensation solution. The compensation solution herein is a brightness compensation value corresponding to each pixel unit in the display panel. For specific determining of the compensation solutions, refer to the determining steps of the first compensation solution, the second compensation solution, and the third compensation solution in the foregoing embodiments.

It may be learned that different brightness intervals correspond to different gray level intervals, different gray level intervals in a same brightness interval correspond to different brightness compensation values, and the brightness compensation value is a difference between a current brightness value of each pixel unit in the display panel in a gray level interval and a target brightness value.

S403. The electronic device obtains a gray level of a to-be-displayed image of the display panel, and compensates each pixel unit in the display panel based on a brightness compensation value corresponding to a gray level interval in which the gray level is located.

In this embodiment of this application, the electronic device obtains the gray level of the to-be-displayed image of the display panel, to be specific, an image processing module in an IC of the electronic device may calculate the gray level of the to-be-displayed image of the display panel. An average value of gray levels of pixel units in the display panel may be calculated as the gray level of the to-be-displayed image of the display panel. Then, the IC of the electronic device selects a corresponding compensation solution based on the gray level interval in which the current gray level is located, to compensate each pixel unit in the display panel.

For example, it is assumed that gray level node values corresponding to the second brightness interval may be 24 and 31. In this case, the gray level node values may constitute corresponding gray level intervals 0-24 (a gray level interval 1), 25-30 (a gray level interval 2), and 31-255 (a gray level interval 3). If the electronic device detects that the display brightness value of the display panel changes from 200 nits to 400 nits, the display brightness value of the display panel changes from the first brightness interval to the second brightness interval. If the electronic device calculates that the current gray level of the display panel is 20, the gray level interval in which the current gray level is located is the gray level interval 1. In this case, the electronic device may select the first compensation solution corresponding to the gray level interval 1, to obtain a brightness compensation value corresponding to each pixel unit in the display panel, and perform brightness compensation on each pixel unit in the display panel. Finally, the electronic device drives the display panel to display an image obtained after brightness compensation.

In this embodiment of this application, to ensure that a display brightness value matches a brightness compensation solution, in other words, to ensure that the display brightness value matches gray level node values corresponding to a brightness interval in which the display brightness value is located, when delivering the current display brightness value, a display driver of the electronic device delivers, to the IC, for example, the image processing module in the IC, in a same frame, gray level node values corresponding to the brightness interval in which the current display brightness value is located. The current display brightness value and the gray level node values corresponding to the brightness interval in which the current display brightness value is located may be packaged and delivered together. The packaging herein means that the current display brightness value and the gray level node values corresponding to the brightness interval in which the current display brightness value is located are placed in a same code packet, and the current display brightness value and the gray level node values corresponding to the brightness interval in which the current display brightness value is located may be delivered together to the IC in a same frame by delivering the code packet. Therefore, it can be ensured that the display driver of the electronic device simultaneously delivers the current display brightness value and the gray level node values corresponding to the brightness interval in which the current display brightness value is located, so that the current display brightness value and the gray level node values corresponding to the brightness interval in which the current display brightness value is located take effect when a same frame of image is displayed.

It may be understood that, the packaging and delivering the current display brightness value and the gray level node values corresponding to the brightness interval in which the current display brightness value is located together is only one implementation of ensuring that the display brightness value and the gray level node values corresponding to the brightness interval in which the display brightness value is located take effect when a same frame of image is displayed. This is not limited in this application, provided that the display brightness value and the gray level node values take effect when a same frame of image is displayed.

In addition, the display brightness value and the gray level node values (which may be referred to as demura nodes) corresponding to the brightness interval in which the display brightness value is located may take effect at inconsistent time after being delivered in a same frame. For example, as shown in FIG. 5, the demura nodes take effect immediately after being delivered, but the display brightness value DBV takes effect at a vertical synchronization (vertical synchronization, Vsync) signal. As a result, the display brightness value does not match a demura interval, causing a problem that a previous demura interval is used for one part of a displayed image and a later demura interval is used for the other part of the displayed image. The Vsync signal is a signal used to indicate that scanning of a previous image frame ends and scanning of a next image frame starts. Specifically, when an application processor (for example, an AP) sends image data of an image frame to the IC (which may be referred to as image sending), gray level node values in the RAM cannot be changed. After the AP completes sending of the image frame, the IC may change the gray level node values in the RAM based on a delivered display brightness value. Therefore, if the display brightness value is delivered at a low level, and the IC is reading the image data from the RAM and displaying the image data on the display panel, the following problem may be caused: a demura interval (alternatively referred to as a previous demura interval) corresponding to the unchanged gray level node values is used for one part of a displayed image and a demura interval corresponding to changed gray level node values in the RAM is used for the other part of the image.

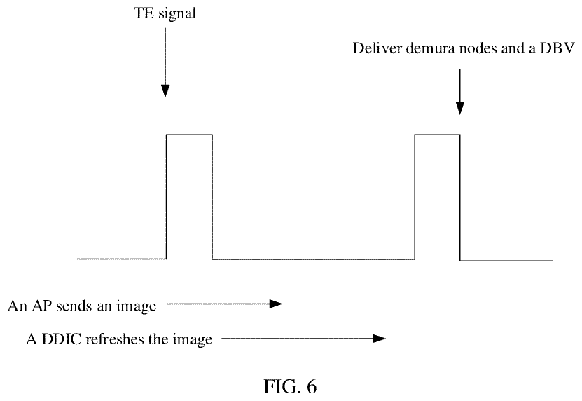

Therefore, to resolve the foregoing problem, the display driver of the electronic device delivers, in synchronization with a TE signal in addition to simultaneously, the display brightness value and the gray level node values corresponding to the gray level interval in which the display brightness value is located, as shown in FIG. 6. To be specific, the display brightness value and the gray level node values corresponding to the gray level interval in which the display brightness value is located are delivered at a Vsync signal, and the display brightness value and the gray level node values corresponding to the gray level interval in which the display brightness value is located are not delivered at a low level.

The demura node herein is a gray level node value, and the demura interval is a gray level interval including the demura node. Each time a display brightness value of the display panel changes across intervals, the electronic device determines, from a storage module that pre-stores mapping relationships between brightness intervals and gray level node values, gray level node values corresponding to a brightness interval in which a current display brightness value is located, and writes the updated gray level node values into the RAM. The IC of the electronic device may perform determining based on a current gray level and the updated gray level node values, and select a corresponding brightness compensation solution to perform brightness compensation on each pixel unit in the display panel, to eliminate a brightness unevenness phenomenon when an image is displayed on the display panel.

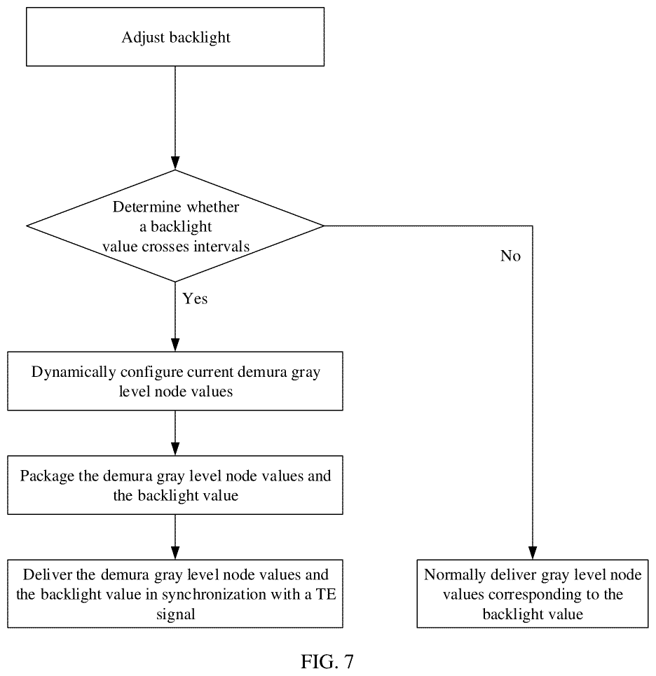

With reference to FIG. 7, the following describes gray level node value adjustment provided in this application by using an example in which the current display brightness value is an adjusted display brightness value, in other words, the display brightness value of the electronic device crosses interval brightness. In a flowchart of adjusting a gray level node value in FIG. 7, the electronic device adjusts a backlight value (a display brightness value), and determines, before the display driver of the electronic device delivers an updated backlight value, whether the backlight value crosses brightness intervals. If the backlight value crosses brightness intervals, the electronic device obtains new gray level node values corresponding to a new brightness interval in which the backlight value is located, and packages the new gray level node values with the backlight value and then delivers the new gray level node values and the backlight value to a kernel layer in synchronization with a TE signal. Then, the electronic device may perform determining based on a current gray level of the display panel and the updated gray level node values, and select a corresponding brightness compensation solution to perform brightness compensation on each pixel unit in the display panel. If the backlight value does not cross intervals, the electronic device may normally obtain gray level node values corresponding to a brightness interval in which the backlight value is located, perform determining based on a current gray level of the display panel and the gray level node values that have been written into the RAM, and select a corresponding brightness compensation solution to perform brightness compensation on each pixel unit in the display panel. In this case, new gray level node values do not need to be written into the RAM of the electronic device, determining may be directly performed based on the current gray level of the display panel and the gray level node values previously stored in the RAM.

In conclusion, this embodiment of this application provides the brightness compensation method for the display panel. Display brightness values of the display panel may be divided into a plurality of brightness intervals in advance, different gray level node values may be correspondingly set for different brightness intervals, and different corresponding brightness compensation values are set for gray level intervals including gray level node values in a same brightness interval. Brightness of the display panel is represented by a display brightness value of the display panel. The electronic device may calculate, for the display panel at a preset gray level based on at least two different pre-selected display brightness values by using a demura algorithm, brightness compensation values respectively corresponding to the different display brightness values. Therefore, after a display brightness value is adjusted, the electronic device may determine corresponding gray level node values based on a brightness interval in which a current display brightness value is located, in other words, determine brightness compensation values respectively corresponding to different gray level intervals including the corresponding gray level node values in the brightness interval. Then, the electronic device selects a corresponding brightness compensation value based on a gray level interval in which a current gray level is located, to perform brightness compensation on each pixel unit in the display panel, so that brightness display unevenness of the display panel can be eliminated.

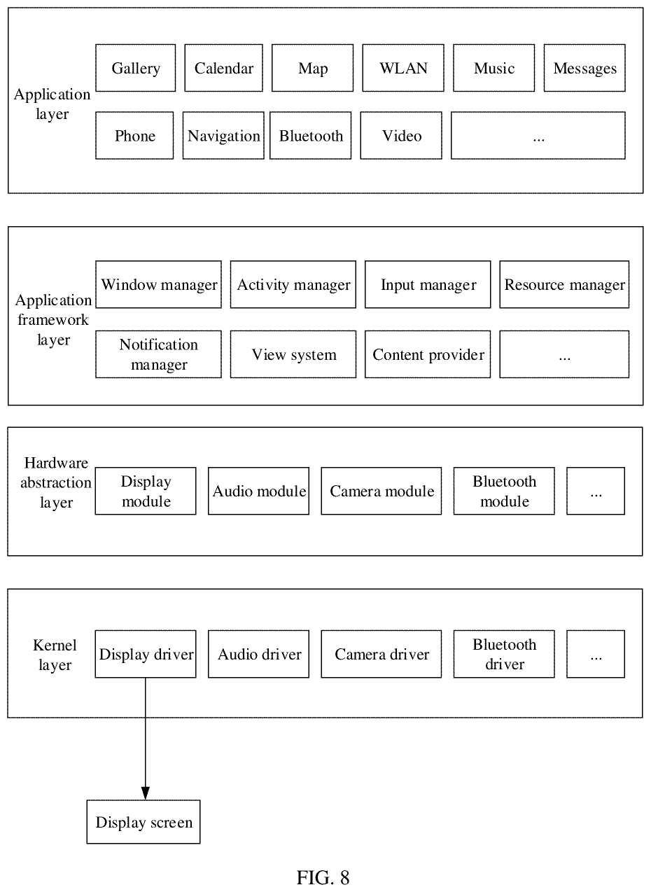

Refer to FIG. 8. FIG. 8 is a software flowchart of adjusting a gray level node value according to an embodiment of this application. In a layered architecture, software is divided into several layers, and each layer has a clear role and task. The layers communicate with each other through software interfaces. In some embodiments, the layers are respectively an application layer, an application framework layer, a hardware abstraction layer, and a kernel layer from top to bottom.

The application layer may include a series of application packages.

As shown in FIG. 8, the application packages may include applications such as Camera, Gallery, Calendar, Phone, Map, Navigation, WLAN, Bluetooth, Music, Video, and Messages. When detecting that backlight brightness changes, the application layer initiates a backlight adjustment procedure to the application framework layer, the hardware abstraction layer, and the kernel layer.

The application framework layer provides application programming interfaces (application programming interface, API) and programming frameworks for the applications at the application layer. The application framework layer includes some predefined functions. As shown in FIG. 8, the application framework layer may include a window manager, a content provider, a view system, a resource manager, a notification manager, an activity manager, an input manager, and the like.

The hardware abstraction layer runs in user space (user space), encapsulates a driver at the kernel layer, and serves as an interface layer between the framework layer and the kernel layer.

The kernel layer is a layer between hardware and software. The kernel layer includes at least a display driver, a camera driver, an audio driver, and a sensor driver. The display driver in the kernel layer adjusts a backlight value and drives a display screen to display an image.

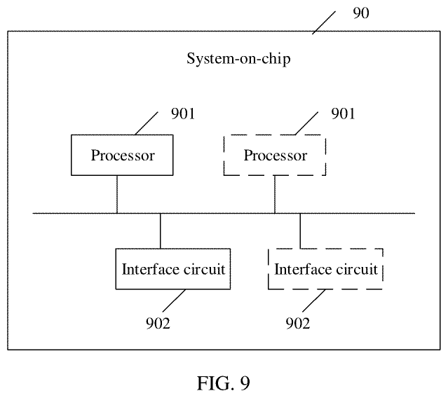

An embodiment of this application further provides a system-on-chip. As shown in FIG. 9, the system-on-chip 90 includes at least one processor 901 and at least one interface circuit 902. The processor 901 and the interface circuit 902 may be connected to each other through a line. For example, the interface circuit 902 may be configured to receive a signal from another apparatus (for example, a memory of an electronic device). For another example, the interface circuit 902 may be configured to send a signal to another apparatus (for example, the processor 901). For example, the interface circuit 902 may read instructions stored in the memory, and send the instructions to the processor 901. When the instructions are executed by the processor 901, the electronic device may be enabled to perform the steps in the foregoing embodiments. Certainly, the system-on-chip may further include other discrete devices. This is not specifically limited in this embodiment of this application.

An embodiment of this application further provides a computer storage medium. The computer storage medium includes computer instructions, and when the computer instructions are run on the foregoing electronic device, the electronic device is enabled to perform the functions or the steps performed by the mobile phone in the foregoing method embodiments.

An embodiment of this application further provides a computer program product. When the computer program product is run on a computer, the computer is enabled to perform the functions or the steps performed by the mobile phone in the foregoing method embodiments.

Based on the descriptions of the foregoing implementations, a person skilled in the art may clearly understand that, for convenience and brevity of description, only division into the foregoing functional modules is used as an example for description. In an actual application, the foregoing functions may be allocated to different functional modules for implementation based on a requirement, in other words, an internal structure of an apparatus is divided into different functional modules, to complete all or some of the functions described above.

In the several embodiments provided in this application, it should be understood that the disclosed apparatus and method may be implemented in other manners. For example, the apparatus embodiments described above are merely examples. For example, division into the modules or units is merely logical function division. In an actual implementation, there may be another division manner. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or the units may be implemented in electronic, mechanical, or other forms.

The units described as separate parts may or may not be physically separate, and parts displayed as units may be one or more physical units, in other words, may be located in one place, or may be distributed in a plurality of different places. Some or all of the units may be selected based on an actual requirement to achieve the objectives of the solutions in embodiments.

In addition, the functional units in embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in a form of a software functional unit and sold or used as an independent product, the integrated unit may be stored in a readable storage medium. Based on such an understanding, the technical solutions in embodiments of this application essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor (processor) to perform all or some of the steps of the method in embodiments of this application. The storage medium includes various media that can store program code, for example, a USB flash drive, a removable hard disk, a read only memory (read only memory, ROM), a random access memory (random access memory, RAM), a magnetic disk, or an optical disc.

The foregoing content is only specific implementations of this application, but the protection scope of this application is not limited thereto. Any variation or replacement made within the technical scope disclosed in this application shall fall within the protection scope of this application. Therefore, the protection scope of this application shall be subject to the protection scope of the claims.

What is claimed is:

1. A brightness compensation method for a display panel, comprising:
when detecting that the display panel displays a to-be-displayed image at a current display brightness value, determining a brightness interval in which the current display brightness value is located, wherein difference information between mura images presented on the display panel at display brightness values in a same brightness interval is within a first preset difference range;
determining gray level intervals corresponding to the brightness interval, wherein the gray level intervals corresponding to the brightness interval are determined based on gray level node values corresponding to the brightness interval, different brightness intervals correspond to different gray level node values, different gray level intervals correspond to different brightness compensation values, and the brightness compensation value is a difference between an actual brightness value of each pixel unit in the display panel in a corresponding gray level interval and a target brightness value; and
obtaining a gray level of the to-be-displayed image, and compensating each pixel unit in the display panel based on a brightness compensation value corresponding to a gray level interval in which the gray level is located.

2. The method according to claim 1, wherein the display panel corresponds to brightness compensation values corresponding to target gray level node values of a plurality of display brightness values in advance, and the brightness interval corresponds to a first gray level interval and a second gray level interval.

3. The method according to claim 2, wherein a brightness compensation value corresponding to the first gray level interval is a brightness compensation value corresponding to a target gray level node value of a first display brightness value in the plurality of display brightness values, and a difference between image information of a mura image corresponding to the first gray level interval and image information of a mura image corresponding to the target gray level node value of the first display brightness value is the smallest; and
a brightness compensation value corresponding to the second gray level interval is a brightness compensation value corresponding to a target gray level node value of a second display brightness value in the plurality of display brightness values, and a difference between image information of a mura image corresponding to the second gray level interval and image information of a mura image corresponding to the target gray level node value of the second display brightness value is the smallest.

4. The method according to claim 3, wherein the brightness interval further comprises a third gray level interval, a gray level in the third gray level interval is greater than a gray level in the first gray level interval, and the gray level in the third gray level interval is less than a gray level in the second gray level interval.

5. The method according to claim 4, wherein a brightness compensation solution corresponding to the third gray level interval is obtained through analysis by using a fitting curve of a brightness compensation value based on the brightness compensation value of the first gray level interval, gray levels of the first gray level interval, the brightness compensation value of the second gray level interval, and gray levels of the second gray level interval, wherein the fitting curve of the brightness compensation value is used to indicate a trend of a change of the brightness compensation value with the gray level interval.

6. The method according to claim 3, wherein
the display panel corresponds to mura images presented at the plurality of display brightness values, and the plurality of display brightness values comprise the first display brightness value and the second display brightness value, wherein difference information between a mura image presented on the display panel at the first display brightness value and a mura image presented on the display panel at the second display brightness value is greater than a second preset difference range, and the second display brightness value is greater than the first display brightness value.

7. The method according to claim 6, wherein
the brightness compensation value corresponding to the target gray level node value of the first display brightness value is obtained by performing brightness compensation on the display panel in the target gray level node value of the first display brightness value; and
the brightness compensation value corresponding to the target gray level node value of the second display brightness value is obtained by performing brightness compensation on the display panel in the target gray level node value of the second display brightness value.

8. The method according to claim 5, wherein
the display panel corresponds to mura images presented at the plurality of display brightness values, and the plurality of display brightness values comprise the first display brightness value and the second display brightness value, wherein difference information between a mura image presented on the display panel at the first display brightness value and a mura image presented on the display panel at the second display brightness value is greater than a second preset difference range, and the second display brightness value is greater than the first display brightness value.

9. The method according to claim 8, wherein
the brightness compensation value corresponding to the target gray level node value of the first display brightness value is obtained by performing brightness compensation on the display panel in the target gray level node value of the first display brightness value; and
the brightness compensation value corresponding to the target gray level node value of the second display brightness value is obtained by performing brightness compensation on the display panel in the target gray level node value of the second display brightness value.

10. The method according to claim 1, wherein
the brightness interval corresponds to the first gray level interval and the second gray level interval; and
a smaller display brightness value in the brightness interval indicates a larger proportion of the first gray level interval corresponding to the brightness interval in a total gray level range, and a smaller display brightness value in the brightness interval indicates a smaller proportion of the second gray level interval corresponding to the brightness interval in the total gray level range.

11. The method according to claim 1, wherein the compensating each pixel unit in the display panel based on a brightness compensation value corresponding to a gray level interval in which the gray level is located comprises:
if the gray level is located in the first gray level interval corresponding to the brightness interval, compensating each pixel unit in the display panel based on the first brightness compensation value corresponding to the first gray level interval;
if the gray level is located in the second gray level interval corresponding to the brightness interval, compensating each pixel unit in the display panel based on the second brightness compensation value corresponding to the second gray level interval; or
if the gray level is located in the third gray level interval corresponding to the brightness interval, compensating each pixel unit in the display panel based on the third brightness compensation value corresponding to the third gray level interval.

12. The method according to claim 1, wherein the method further comprises:
in response to a scanning start signal of the to-be-displayed image, packaging and delivering, to a display driver, the current display brightness value and a gray level node value corresponding to the current display brightness value together.

13. The method according to claim 1, wherein the method further comprises:
in response to an adjustment instruction of a user for a display brightness value of the display panel, detecting the current display brightness value of the display panel, wherein the adjustment instruction is used to indicate that the current display brightness value of the display panel changes across intervals.

14. The method according to claim 1, wherein the method further comprises:
when detecting that ambient light brightness of the display panel changes, detecting the current display brightness value of the display panel.

15. The method according to claim 1, wherein after the obtaining a gray level of the to-be-displayed image of the display panel, and compensating each pixel unit in the display panel based on a brightness compensation value corresponding to a gray level interval in which the gray level is located, the method further comprises:
driving the display panel to display the to-be-displayed image.

16. An electronic device, wherein the electronic device comprises a display screen, a memory, and one or more processors; the display screen comprises a display panel; the display screen, the memory, and the processors are coupled; and the memory is configured to store computer program code, the computer program code comprises computer instructions, and when the computer instructions are executed by the electronic device, the electronic device is enabled to execute:
when detecting that the display panel displays a to-be-displayed image at a current display brightness value, determining a brightness interval in which the current display brightness value is located, wherein difference information between mura images presented on the display panel at display brightness values in a same brightness interval is within a first preset difference range;
determining gray level intervals corresponding to the brightness interval, wherein the gray level intervals corresponding to the brightness interval are determined based on gray level node values corresponding to the brightness interval, different brightness intervals correspond to different gray level node values, different gray level intervals correspond to different brightness compensation values, and the brightness compensation value is a difference between an actual brightness value of each pixel unit in the display panel in a corresponding gray level interval and a target brightness value; and
obtaining a gray level of the to-be-displayed image, and compensating each pixel unit in the display panel based on a brightness compensation value corresponding to a gray level interval in which the gray level is located.

17. The electronic device according to claim 16, wherein the electronic device is further enabled to execute:
in response to an adjustment instruction of a user for a display brightness value of the display panel, detecting the current display brightness value of the display panel, wherein the adjustment instruction is used to indicate that the current display brightness value of the display panel changes across intervals.

18. The electronic device according to claim 16, wherein the electronic device is further enabled to execute:
when detecting that ambient light brightness of the display panel changes, detecting the current display brightness value of the display panel.

19. The electronic device according to claim 16, wherein after the obtaining a gray level of the to-be-displayed image of the display panel, and compensating each pixel unit in the display panel based on a brightness compensation value corresponding to a gray level interval in which the gray level is located, the electronic device is further enabled to execute:
driving the display panel to display the to-be-displayed image.

20. A computer-readable storage medium, wherein the computer-readable storage medium stores computer instructions, and when the computer instructions are run on an electronic device, the electronic device is enabled to execute:
when detecting that the display panel displays a to-be-displayed image at a current display brightness value, determining a brightness interval in which the current display brightness value is located, wherein difference information between mura images presented on the display panel at display brightness values in a same brightness interval is within a first preset difference range;
determining gray level intervals corresponding to the brightness interval, wherein the gray level intervals corresponding to the brightness interval are determined based on gray level node values corresponding to the brightness interval, different brightness intervals correspond to different gray level node values, different gray level intervals correspond to different brightness compensation values, and the brightness compensation value is a difference between an actual brightness value of each pixel unit in the display panel in a corresponding gray level interval and a target brightness value; and
obtaining a gray level of the to-be-displayed image, and compensating each pixel unit in the display panel based on a brightness compensation value corresponding to a gray level interval in which the gray level is located.
